(19) United States
(12) Patent Application Publication
(10) Pub. No.: US 2004/0198453 A1
(43) Pub. Date: Oct. 7, 2004

(54) Distributed wireless network employing utility poles and optical signal distribution

(76) Inventors: David Cutrer, Fremont, CA (US); Sanjay Mani, Palo Alto, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/313,927

(22) Filed: Dec. 5, 2002

Related U.S. Application Data
(60) Provisional application No. 60/412,498, filed on Sep. 20, 2002.

(51) Int. Cl. H04M 1/00

(52) U.S. Cl. 455/562.1; 455/561

(57) ABSTRACT

Methods and apparatus for providing wireless data or voice coverage in a region by employing existing poles as part of a distribution network. Base station equipment is placed in a co-location facility, and then the BTS signals are distributed over a communication network to remote pole locations, where the signal is radiated from antennas mounted on the poles. This coverage can employ various current and future standards, including cellular standards such as GSM, CDMA, and UMTS, and IP data standards such as 802.11a and 802.11b.

### CROSS-REFERENCE TO RELATED APPLICATIONS

This application claims the benefit of U.S. Ser. No. 60/412,498, filed Sep. 20, 2002, which application is fully incorporated herein by reference.

### BACKGROUND OF THE INVENTION

1. Field of the Invention

This invention relates generally to optical and wireless networks, and more particularly to physical equipment design for embedding in streetlamps, utility poles, and other urban poles.

2. Description of the Related Art

Cellular networks are currently deployed by co-locating antennas and base stations at sites that are either bought or leased and can support such installations. Typical sites include rooftops (FIG. 1) and towers (FIG. 2). In FIG. 1, an antenna is placed on a rooftop, and the base station equipment placed on the top floor of the building. In FIG. 2, the base station is placed in a protective enclosure, a high tower is installed, and then the antenna is placed at the top of the tower. In both implementations, the downlink RF signal is emitted by a power amplifier. Such amplifiers are large, heavy, and require a large amount of electrical power. Part of their large size is due to large heat dissipation requirements. The traffic from this base station would then be backhauled to the switching network via several T-1 data links. Unfortunately, the base station equipment can be heavy, large, and have extensive power and environmental requirements, which make it difficult to site. Furthermore, the network is difficult to maintain because complex pieces of equipment are distributed throughout the network. In addition, the traffic from each base station must be individually backhauled back to the switching network.

Rooftop and tower sites are not easily acquired, because of the extensive zoning and real estate requirements for placing BTS equipment and an antenna at a given location. FIG. 3 depicts a typical network coverage deployment architecture. Due to the specificity of the cellular network layout, the antenna sites must be placed in a very specific location, often a city block, making the site placement problem even more difficult. Without this specificity, a cellular network cannot effectively cover a geographic region. As network traffic continues to grow, density of cell sites needs to increase, which creates a need for more sites at specific locations. These new locations must not only provide desired coverage, but not interfere with the existing sites. New sites are increasingly difficult to find, acquire zoning permits for, and lease.

An alternate deployment architecture is occasionally used for difficult to cover areas, such as buildings or narrow canyons. This architecture is illustrated in FIG. 4. A proprietary point-to-point repeater link is used in which the near end is connected to the base station and the far end is connected to the antennas. In FIG. 4, the link is an optical fiber link, which carries uplink and downlink signals from one or a series of antennas to a base station over optical fiber. The uplink and downlink signals can be placed on 2 fibers, or can be placed on different wavelengths on the same fiber. Typical wavelengths employed for this type of equipment are 1550 nm and 1310 nm. The repeater approach allows for the base station equipment to be remotely located from the antenna placement. This makes antenna placement in difficult areas, like canyons or buildings, easier, because the remote repeater units are much smaller and more rugged than standard BTS equipment. In FIG. 4, the antenna has been placed on a utility pole at some distance from the BTS equipment. The point-to-point links can take several formats, in FIG. 4, an analog optical repeater is employed over a fiber link to connect a base station to a remote antenna.

Technologies exist that provide a single link for a radio signal to be transmitted in an analog fashion over some distance. The signal can be downconverted to an IF or sent at RF. Analog links can be over several media, including single mode fiber, multi-mode fiber, coaxial cable, etc. Several inventions have been proposed in this domain, over fiber, they employ pairs of optical transmitters/receivers to send uplink and downlink signals over a fiber length. The two ends are connected to the antenna and the base station. Another solution to providing a point-to-point repeater from a cellular antenna to a base station is to digitize the analog signal, transmit it digitally over an optical link, and then convert it back to an analog signal. Such a system is illustrated in FIG. 5. An analog RF signal is downcoverted to baseband, sampled, and then the digital signal is converted to an optical signal and transmitted over an optical link. At the far end, the digital signal is converted back into an analog signal, upconverted to the RF band, and transmitted. Although only one direction is illustrated, clearly a duplex link can be created.

Schemes for digitizing the bandwidth of a cellular signal using down conversion to baseband followed by an A/D converter and a parallel-to-serial converter exist. This converts an analog signal to a raw digital bit stream. The reverse conversion, serial to parallel converter, followed by a D/A converter and then up conversion, allows for conversion of this raw digital bit stream back to an analog signal. Digital transmission requires down conversion, unlike analog transmission which may occur at RF. It also, however, greatly mitigates reduction in signal dynamic range from the link properties, since as long as sufficient signal-to-noise ratio is maintained and enough sampling bits are used, the signal dynamic range is not significantly affected.

Raleigh fade, caused by multi-path interference, is a common problem in cellular systems. It is typically addressed by employing 2 or more receive antennas, placed at a spacing of at least the operating wavelength, as illustrated in FIG. 6. This is known as receive diversity. It is very unlikely that the same multi-path interference would occur at 2 separate spatial antenna locations simultaneously, so this type of fading is effectively combated by receive diversity.

### DESCRIPTION OF THE DRAWINGS

FIG. 1—Typical rooftop cellular site. In this site, an antenna is placed on the rooftop, connected with coaxial RF cable to a base station radio/transceiver (BTS) unit. The BTS equipment includes large downlink power amplifiers. This unit is then backhauled to the cellular network.

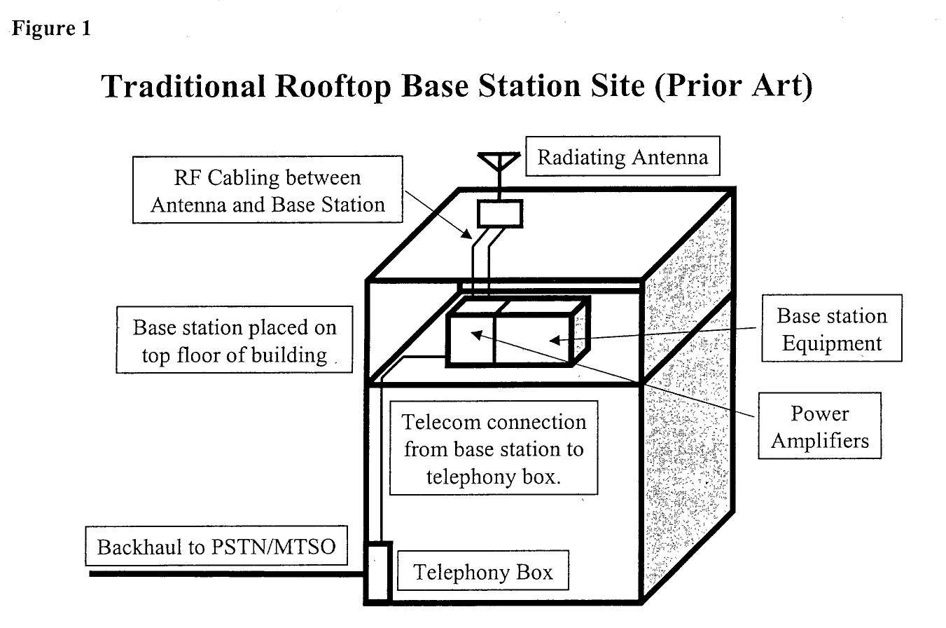

FIG. 2—Typical tower cellular site. In this site, an antenna is placed on the top of a tower, connected with coaxial RF cable to a base station radio/transceiver (BTS) unit, which is placed in a protective enclosure. This radio/transceiver is then backhauled to the cellular network. The BTS equipment includes large downlink power amplifiers.

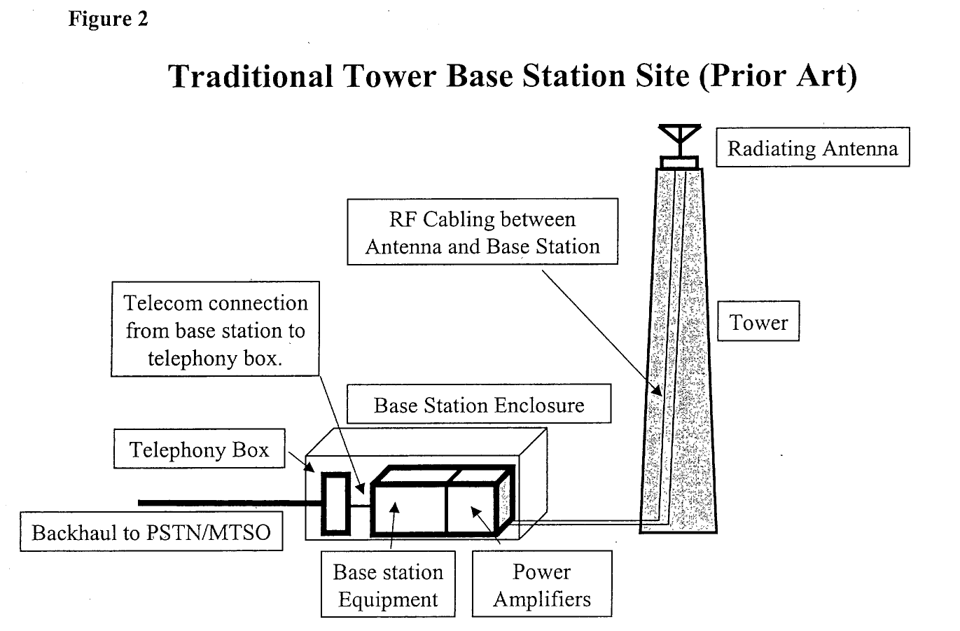

FIG. 3—Typical deployment of cellular network. Base station/antenna sites are located at specific points across a geographic area chosen to provide coverage. Each site is backhauled to the cellular network via 1 or more T-1 digital links.

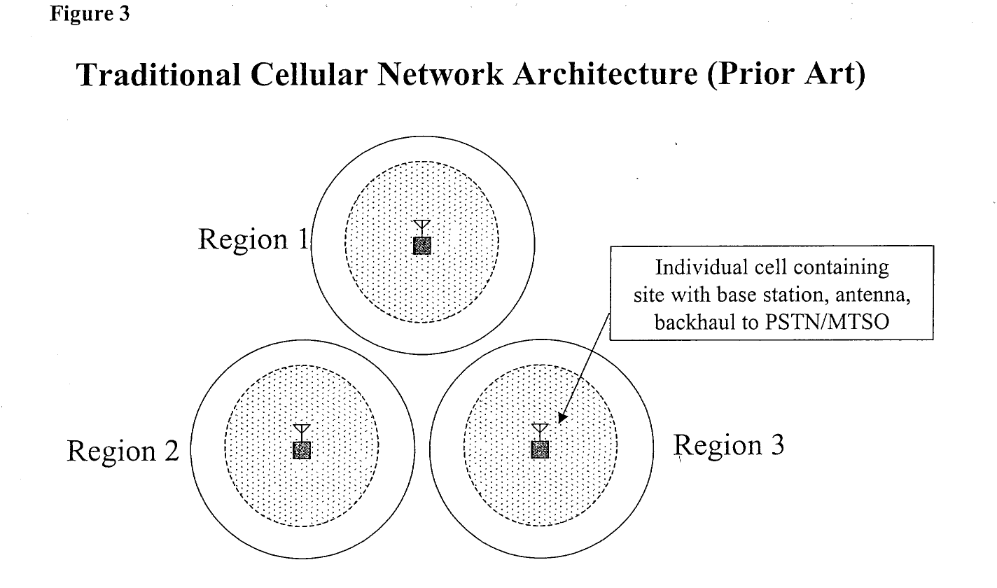

FIG. 4—Analog repeater connecting a remote antenna to a base station over an optical fiber link. The base station equipment along with the optical repeater host equipment is placed in one location, and then connected over fiber to a remote location, such as a utility pole in a canyon. The remote repeater equipment is placed at the utility pole, along with the remote antenna for transmission and reception. Both uplink and downlink signals can be carried on a single optical fiber, using standard WDM multiplexing at 1310 nm and 1550 nm.

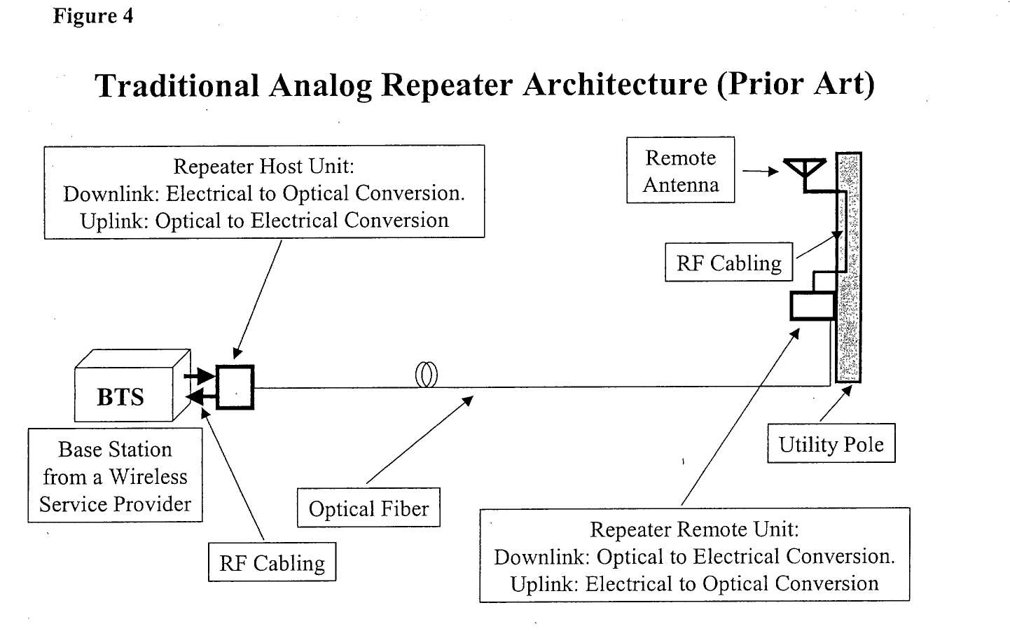

FIG. 5—Transmitter and receiver chain for transmission of antenna signal over a digital link. The signal is down converted, sampled, digitized, and then transmitted in digital format. This signal is then converted back into an analog signal through the reverse process. Such a link is implemented both for uplink and downlink signals.

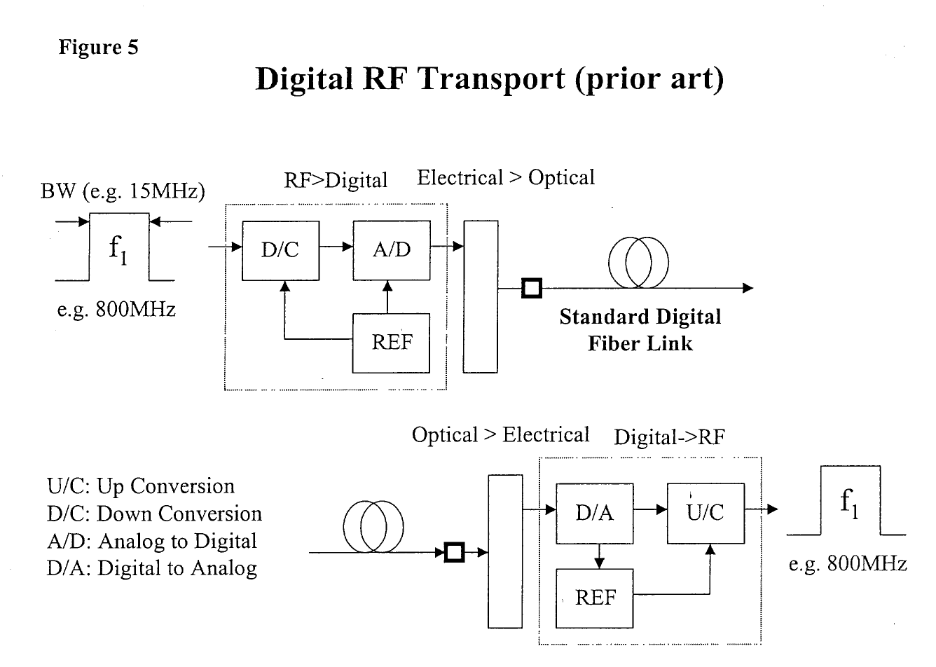

FIG. 6—Diversity receive. Two receive antennas are employed to combat Raleigh fading.

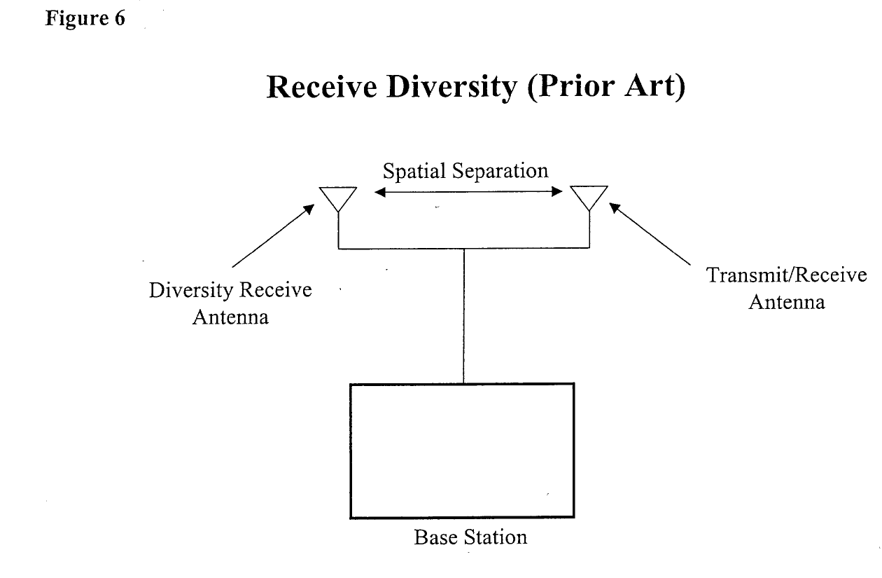

FIG. 7—A single pole-mounted antenna employing an optical network to remotely distribute the BTS signal. BTS equipment is located at a co-location facility, and a converter box is employed to convert RF signals to optical signals for downlink, and optical signals to RF signals for uplink. The BTS signal is the distributed optically to pole location. At the pole location, a remote converter/amplifier unit is employed to convert the optical signals to RF signals for downlink, and RF signals to optical signals for uplink. At the remote pole, an amplifier can also be placed in the downlink path to amplify the radiated signal, and in the uplink path to amplify the receive signal. A single pole element is illustrated.

FIG. 8—Distributed fiber fed pole-mounted antenna architecture. Several remote antennas are fed over an optical network from a single co-location facility holding BTS equipment for multiple remote sites, along with optical/RF converter equipment. Each remote site consists of a remote converter/amplifier unit, and potentially a network discriminator element to pick off the correct signal for the remote location.

FIG. 9—A single pole-mounted antenna employing an optical repeater system to remotely distribute the BTS signal. BTS equipment is located at a co-location facility, and a base repeater optical/electrical converter (O/E) box is employed to convert RF signals to optical signals for downlink, and optical signals to RF signals for uplink. The BTS signal is the distributed over optical fiber to pole location. At the pole location, a remote repeater O/E converter/amplifier unit is employed to convert the optical signals to RF signals for downlink, and RF signals to optical signals for uplink.

FIG. 10—Free space link fed pole-mounted antenna architecture. Remote equipment mounted on pole is connected to communications network over free space link. Link can be optical or RF. Remote equipment couples RF on antenna side to RF/communications format converter, which is in turn connected to a free space link transport medium. On network side is a symmetric free space link unit. The BTS equipment is connected to an RF/communications network format converter, which is connected over a communications network to the near end of the free space link unit. In a simple case, the communications network could be a simple cable, and the free space unit could be connected directly to the converter unit.

FIG. 11—Optical digital free space link fed pole-mounted antenna architecture. Remote equipment mounted on pole is connected to communications network over free space optics (FSO) link. Remote equipment converts RF on antenna side to an optical digital fiber signal, which is in turn converted to an FSO signal. On the network side, the free space optical link converts between FSO signals and optical signals. This FSO link is connected to a digital optical communications link, which is in tern connected to a device which converts between digital optical signals and analog RF signals. This final converter is connected to the BTS equipment to an optical signal. The optical signal is a digital signal, which is converted into an analog RF signal. In a simple case, the communications network could be an optical cable, and the free space unit could be connected directly to the converter unit.

FIG. 12—Double star free space/wired communications network infrastructure. A wired infrastructure such as optical fiber is links the base station co-location facility to remote hub nodes. The hub nodes are linked to remote radiating nodes through a free space link, such as an optical free space link. Remote hub equipment converts the signals between the first wired infrastructure and free space signals. Remote equipment mounted on or near the pole converts signals between free space signals and RF signals.

FIG. 13—Double star wired poles communications network infrastructure. A first optical wired infrastructure such as single mode optical fiber is links the base station co-location facility to remote hub nodes. The hub nodes are linked to remote radiating nodes through a second type of electrical wired infrastructure, such as coaxial cable or CAT V cable. Remote hub equipment converts the signals between the optical and electrical wired infrastructures. Remote equipment mounted on or near the pole converts signals between the electrical wired infrastructure and RF signals.

FIG. 14—Employ multiple antennas placed on different poles to create diversity receive. A receive signal in from a mobile unit can be received by remote units attached to antennas on different poles. The multiple signals are carried back to the base station location, and the highest signal is chosen or multiple signals are combined to create a receive signal with higher immunity to uplink fades from spatial receive diversity.

FIG. 15—Bonding power amplifier to metal pole via heat conductive media in order to assist heat dissipation. The amplifier is mounted outside the pole, and then connected to the pole via a heat conductive plate that is formed to bond effectively to both the power amplifier and the pole.

FIG. 16—Bonding power amplifier to metal pole via heat conductive media in order to assist heat dissipation. The amplifier is mounted inside the pole, and then connected to the pole via a heat conductive plate that is formed to bond effectively to both the power amplifier and the pole. A weatherproofed venting system is placed at the top of the pole to assist heat dissipation.

FIG. 17—Dual band system. This system transports 2 signals from 2 different frequency bands. Two base stations are connected to the electrical-optical hub conversion system co-located with the base stations. This hub then transports the signals optically to the remote location, the 2 signals can be multiplexed in various ways on over the link, including different optical wavelengths, different RF frequencies on the same wavelength, or different optical fibers. At the remote end, the electrical-optical conversion unit is in turn connected to 2 transmit/receive units for each frequency band, which are connected to a frequency duplexer and then to a dual band transmit/receive antenna.

FIG. 18—Power for the remote unit placed at the utility or lamp pole location is fed through the same conduit system that feeds power to the pole, with an independent line.

FIG. 19—Power for the remote unit placed at the utility or lamp pole location is pulled off of either the power line, for a power pole, or the power supply line for a lamp pole. A transformer/power converter is employed to convert existing power into the power required by the remote unit.

### DETAILED DESCRIPTION OF THE PREFERRED EMBODIMENTS

One embodiment of the present invention provides methods and apparatus that are directed to providing wireless coverage in a region by employing existing poles (utility, streetlamp, telephone, etc.) as part of a distribution network. Base station equipment is placed in a co-location facility, and then the BTS signals are distributed over a communication network to remote pole locations, where the signal is radiated from antennas mounted on the poles. This coverage can be for wireless data or voice, and can employ various current and future standards, including cellular standards such as GSM, CDMA, and UMTS, and IP data standards such as 802.11a and 802.11b.

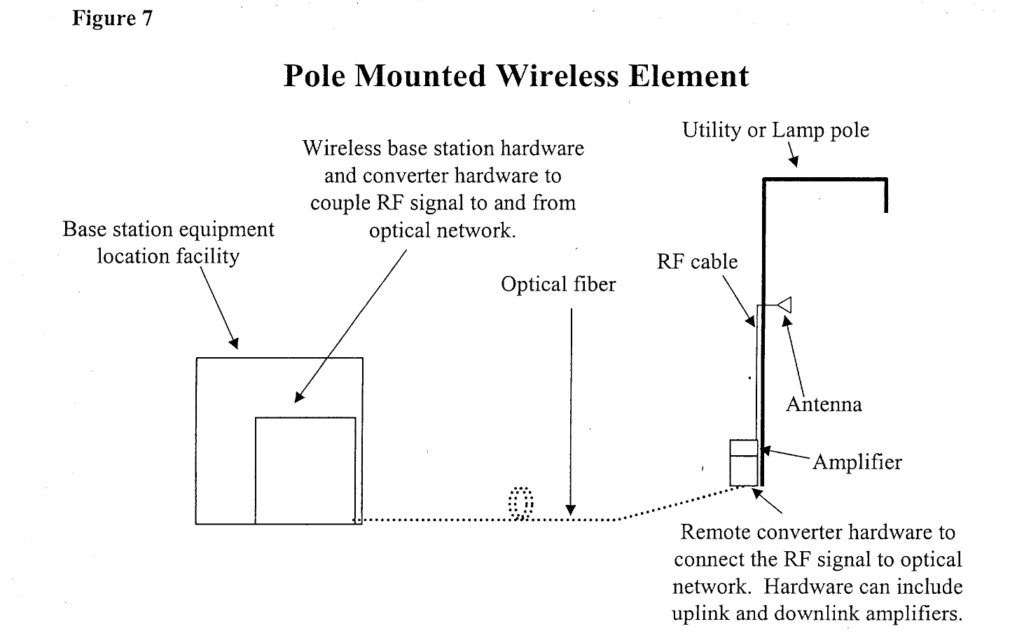

In one embodiment of the invention, the network is an optical network. The antennas that radiate RF are placed on poles, and associated converter hardware is located at the pole location to amplify wireless cellular signals and connect them to an optical network by optical/RF conversion. This is illustrated in FIG. 7 for single remote element. The base station equipment is placed in a co-location facility and connected to a converter that couples the BTS equipment to an optical network. The optical network transports an optical representation of the wireless cellular signals. Therefore, the base station equipment and the remote antennas are connected with converter units and an optical communication network.

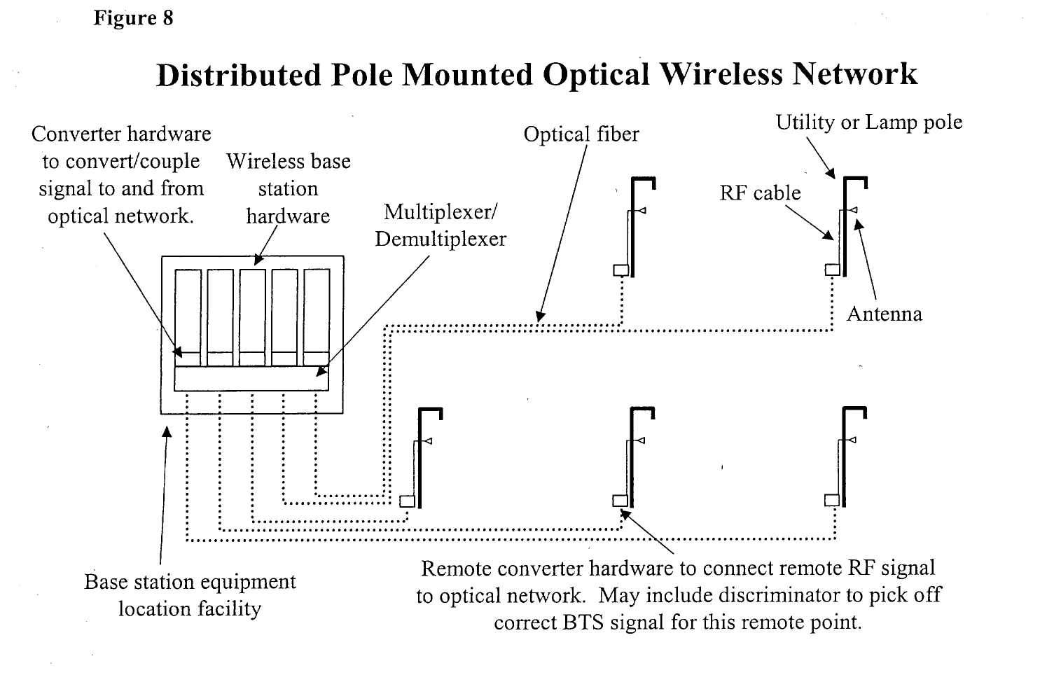

In this embodiment of the invention, many remote elements can be connected to a facility that holds the equipment for all these remote elements, illustrated in FIG. 8. The optical network can employ various forms of multiplexing to carry multiple signals. In a preferred embodiment of the invention, optical wavelength multiplexing can be employed. Other forms of multiplexing including multiple optical fibers, time division multiplexing, and RF frequency division multiplexing can also be employed. The remote elements can contain discriminators to select the proper signal. These discriminators can be optical, such as a Optical Add/Drop Module (OADM) to drop a given optical wavelength, or electrical, such as time-division de-multiplexer. At the co-location facility, multiple downlink signals are multiplexed onto the network and uplink signals are de-multiplexed into the correct BTS radio receivers.

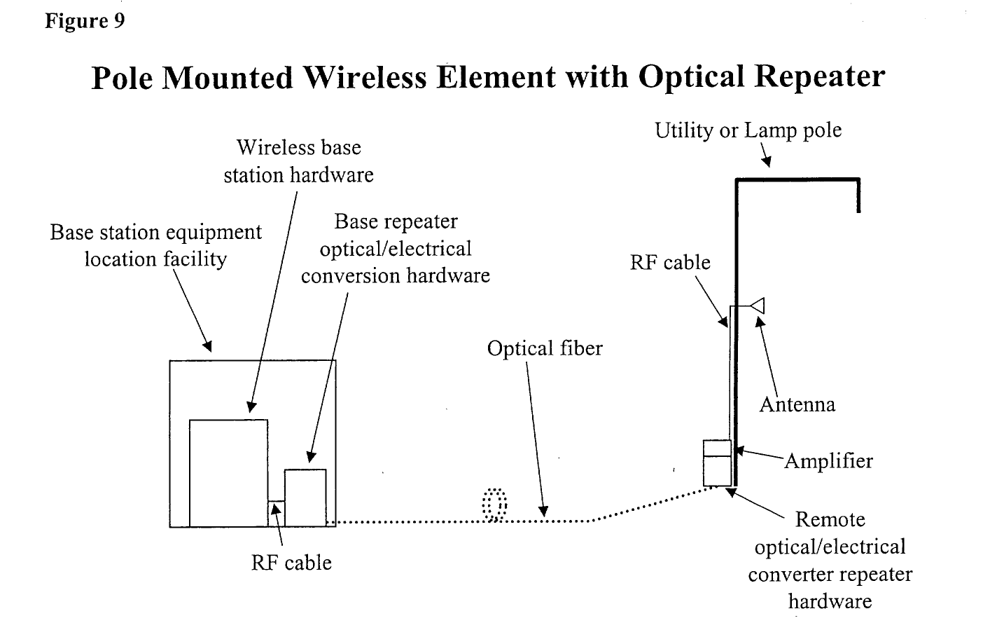

In an embodiment of the invention, the BTS equipment is connected to the optical network by a host repeater unit, and the remote system on the pole is a remote repeater unit. This is illustrated in FIG. 9. As in FIG. 8, this equipment can then be connected to network multiplexing equipment, such as optical multiplexing equipment, to put multiple RF signals on the same optical network.

In a preferred embodiment of this invention, small low power remote downlink amplifier units can be placed at pole locations alongside antennas, while the BTS equipment is placed in co-location facilities. In a preferred embodiment of the current invention, the co-located BTS equipment need not employ large downlink power amplifiers.

In one embodiment of the present invention, conduits that feed electrical power to the distribution poles are employed to distribute optical fiber to the distribution poles.

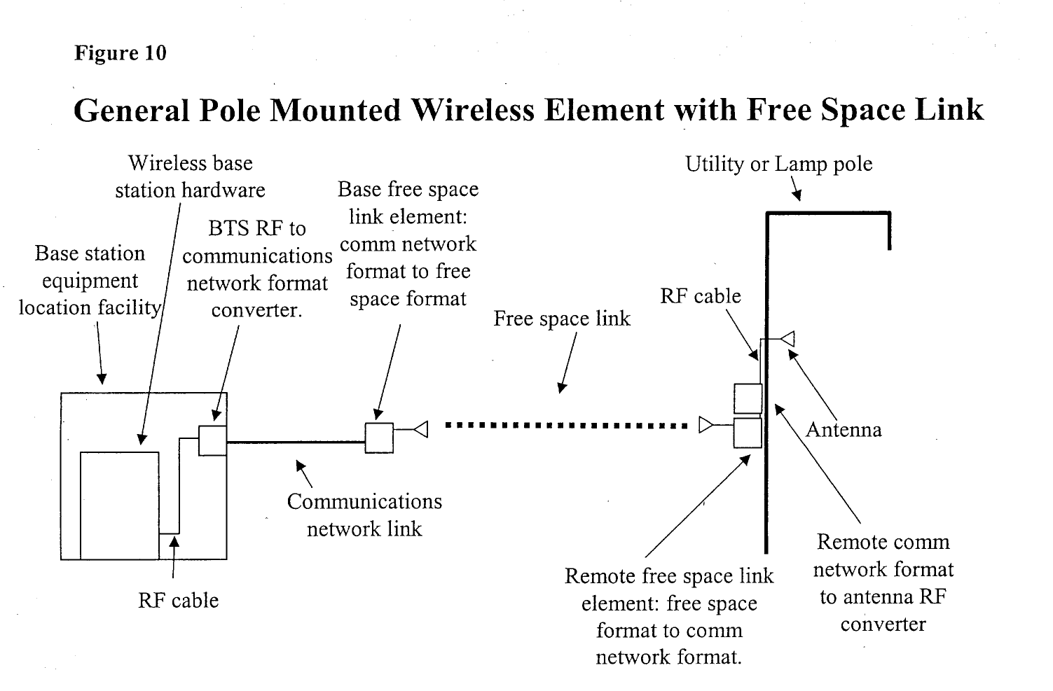

In another embodiment of the current invention, a free space system is employed to form a duplex link to the remote equipment on the utility pole and transmit/receive the BTS signal across it. The general case is illustrated in FIG. 10. The free space link can form the last link in a communications network to the remote pole, or the BTS equipment can be co-located with the near side free space equipment. On the downlink path, a converter links the BTS RF signal to a communications network, and then at the end of the communications network, a free space unit to takes the communications network signal and converts it into a free space signal, to reach the remote pole location.

On the remote pole, a device converts the free space signal back to the communications link format, and then another device converts the communications signal back into an RF signal to feed to the antenna. Format conversion from wired communications network to free space can take may forms, depending on the nature of the free space link.

As an illustration, but not by way of limiting the potential forms, free space links include conversion of an optical wired signal to an optical free space signal without electrical conversion, optical-electrical-optical conversion, RF free space links that accept an optical or electrical input bit stream or analog waveform of a completely different format, and optical wireless links that take various electrical inputs. The whole link functions in the reverse direction on the uplink. In a preferred embodiment, the free space link is free space optics. In a preferred embodiment, the communications link format is a digital optical signal. In another embodiment, the link can involve conversion of the analog RF signal into an analog optical signal.

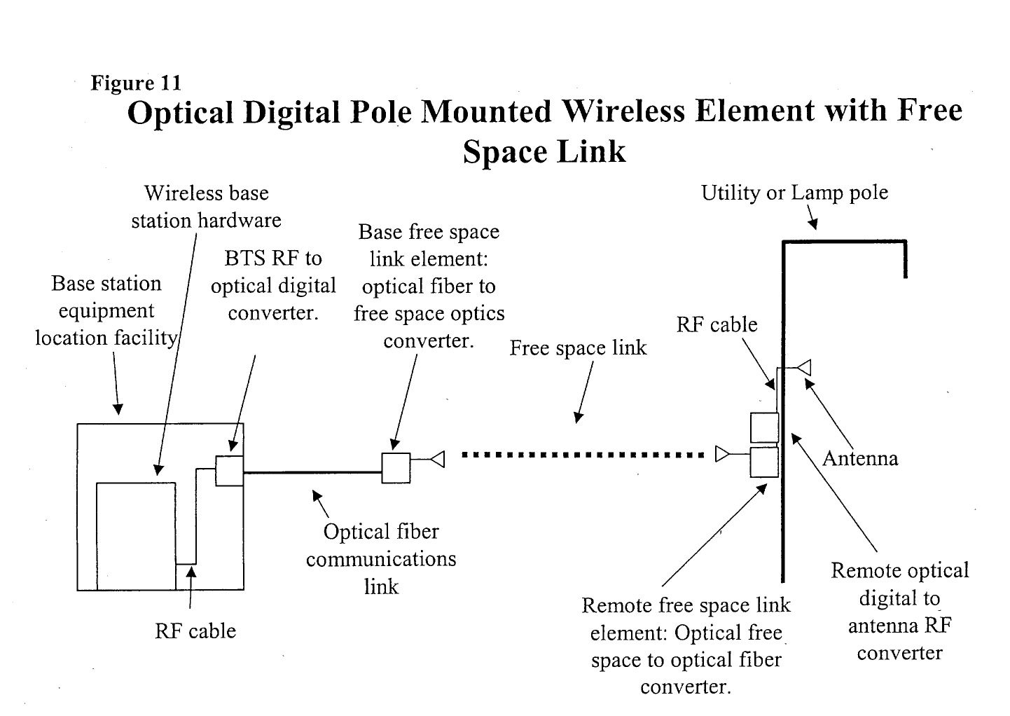

FIG. 11 illustrates a link in which the RF signal is converted to a digital optical signal, and then this digital optical signal is converted to a free space optics signal. In another embodiment, the free space link is RF. The link can involve conversion of the analog RF signal into a digital or analog RF signal.

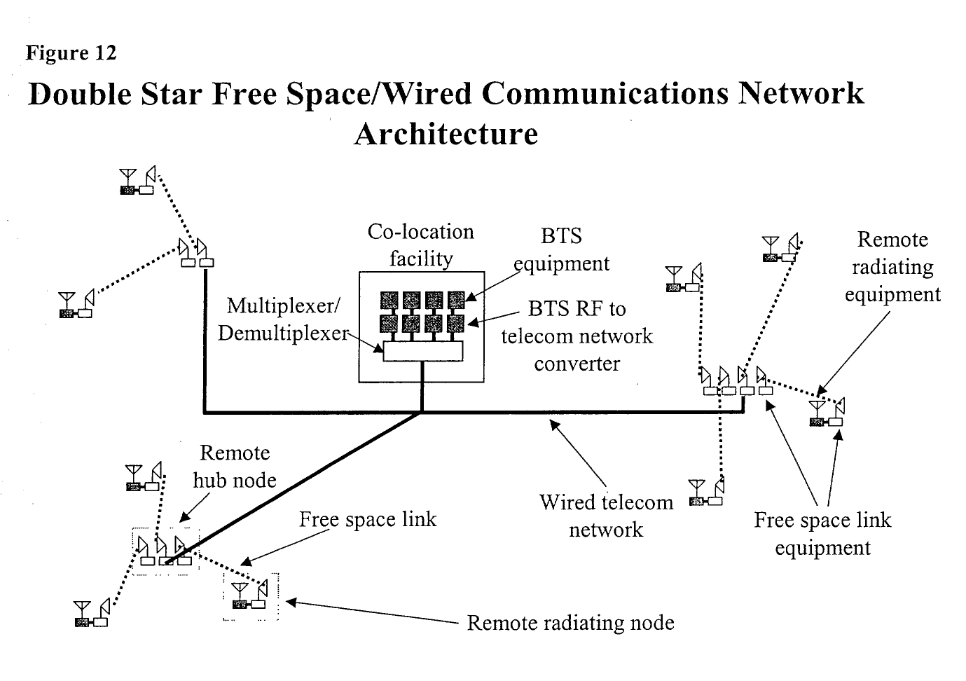

A potential implementation of the architecture with free space links is a double star architecture, in which wired communications network distributes the signals to point locations, which then launch the signals to the remote poles over free space links. This is illustrated in FIG. 12.

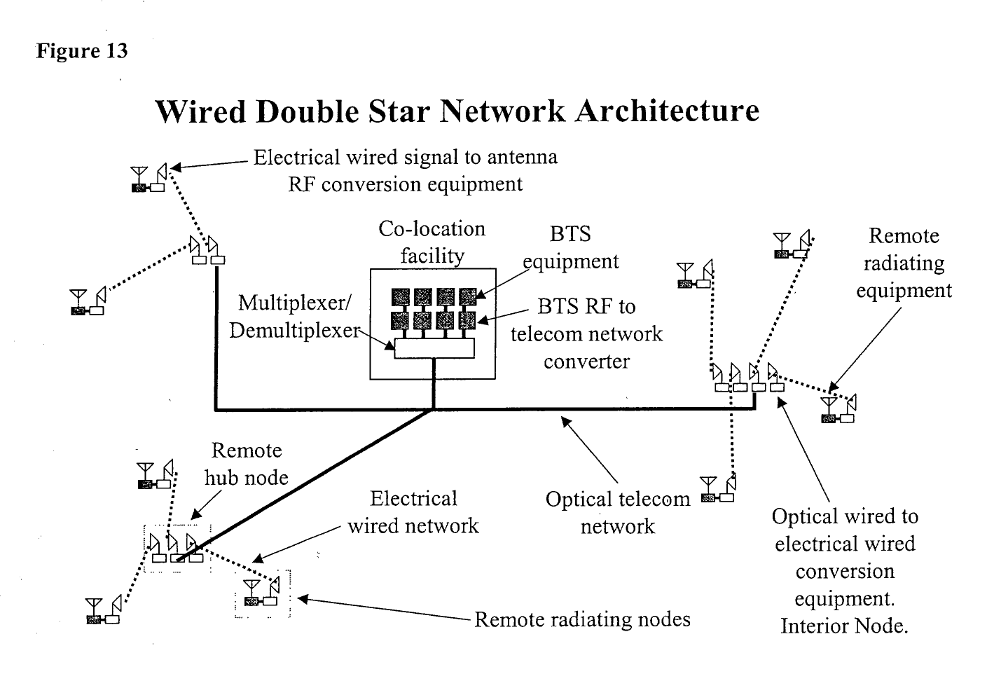

Another set of embodiments of the present invention employs links other than optical fiber or free space links to connect antennas placed on poles with base stations. The other transport mediums can be RF wired links, such as CAT V or co-axial cable. They can be employed in a double star architecture, as illustrated in FIG. 13, or they can form the entire communication network. Repeater hardware is employed to convert the wireless RF signal into the signal for the transport medium, and back again. Over the transport network, native optical and electrical drivers and routing equipment is used.

One embodiment of the invention takes advantage of a dense spacing of antennas to provide diversity reception to combat multipath fading, by selectively combining signals from antennas placed on different poles. This selective combination can employ existing multiple receive diversity ports on the BTS equipment, or a dedicated diversity receive system. A dedicated device can be employed which determines the receive signal level from several antennas for a given transmission, and employs the highest level.

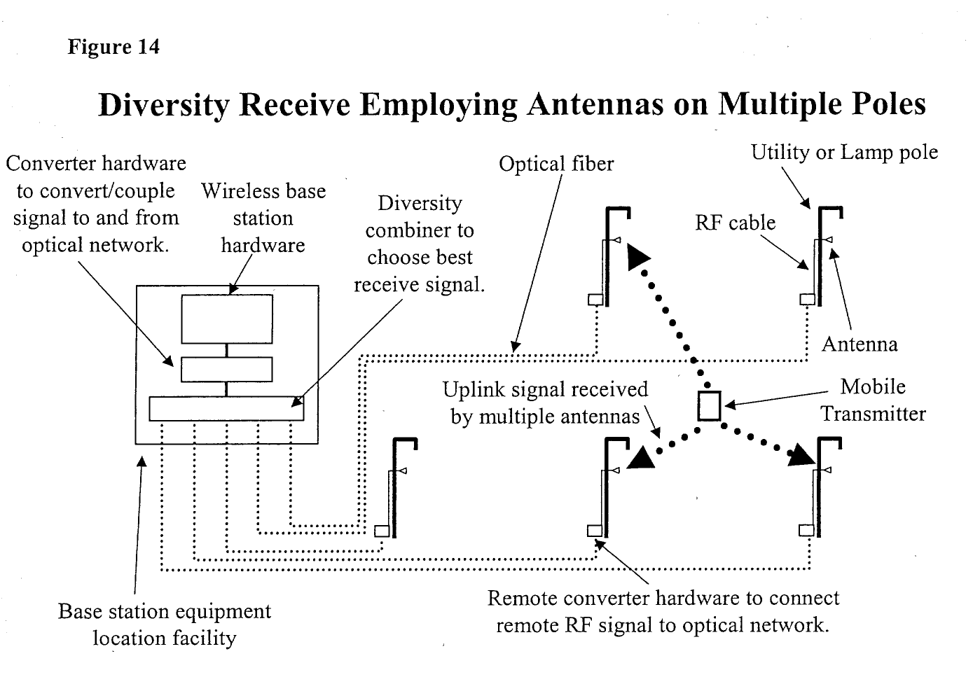

This is illustrated in FIG. 14. CDMA, a widely used cellular standard, already employs a similar mechanism in soft handoff, in which the optimal receive signal is chosen from multiple base stations by the MSC (Mobile Switching Center). This technique would be extremely effective in the pole receive network, and would mitigate the need for multiple receive antennas on each pole.

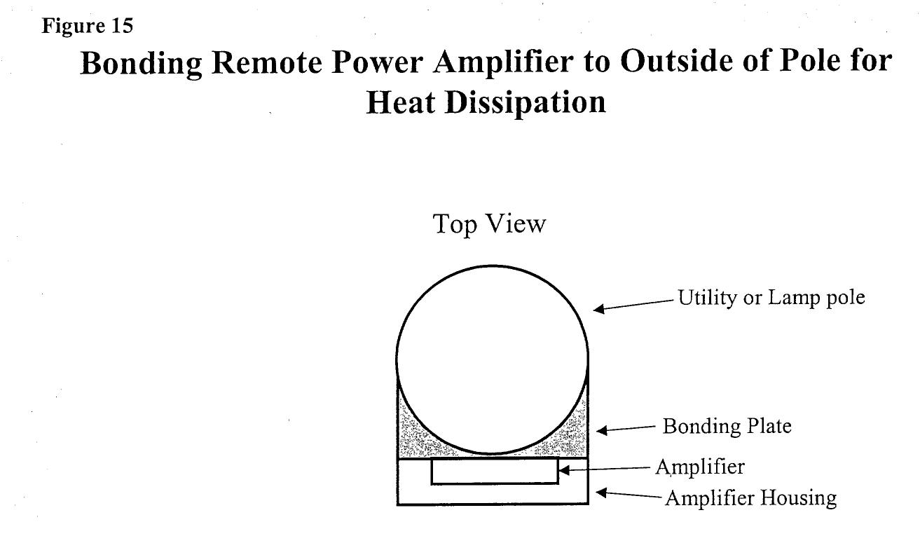

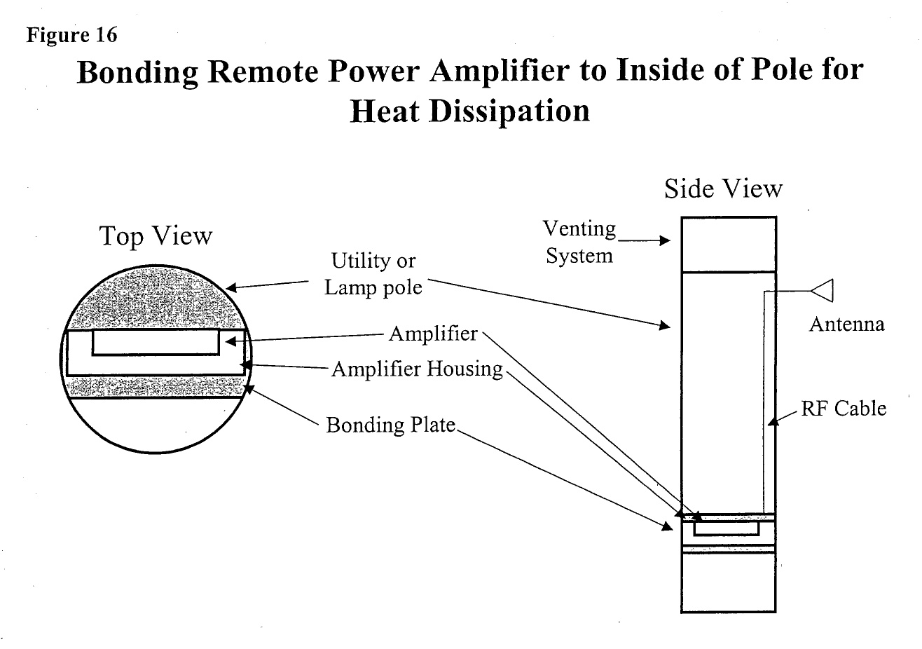

Employing streetlamps and similar poles radiating points for wireless system requires employing small devices that fit on or in the pole. In the current invention, a crucial size driver is the need to dissipate power from the RF amplifiers needed to transmit the downlink signal. One solution is to bond the amplifier to a metal light or utility pole, and use that metal as the heat dissipater. The amplifier would be bonded to its housing through a heat conductive bond, and then the housing bonded to the metal pole through an intermediary head conductive plate which is fitted on one side to bolt to the pole and flat on the other side to bond amplifier housing. This is illustrated in FIG. 15 for an amplifier mounted on the outside of a pole. The plate could be bonded to each side with a heat conductive adhesive to increase heat conductivity. In FIG. 16, the amplifier is placed on the inside of the pole, and then bonded to the pole through a properly formed heat conductive plate. To assist in heat dissipation when the amplifier is on the inside of the pole, a weatherproofed venting system is placed at the top of the pole.

An additional embodiment of this invention is to share it between multiple wireless operators, both voice and data, and for it to be operated and implemented by a neutral host provider. This allows the costs of infrastructure to be shared across multiple operators. Since there are many methods of multiplexing multiple cellular signals over such wired and free space communications networks, these multiplexed methods can be employed to service multiple operators. In one embodiment, multiple optical wavelengths can be employed for multiple operators. In another embodiment, multiple time slots can be employed for multiple operators. In a preferred embodiment, two different RF frequencies can be used to transport the two signals over the optical link.

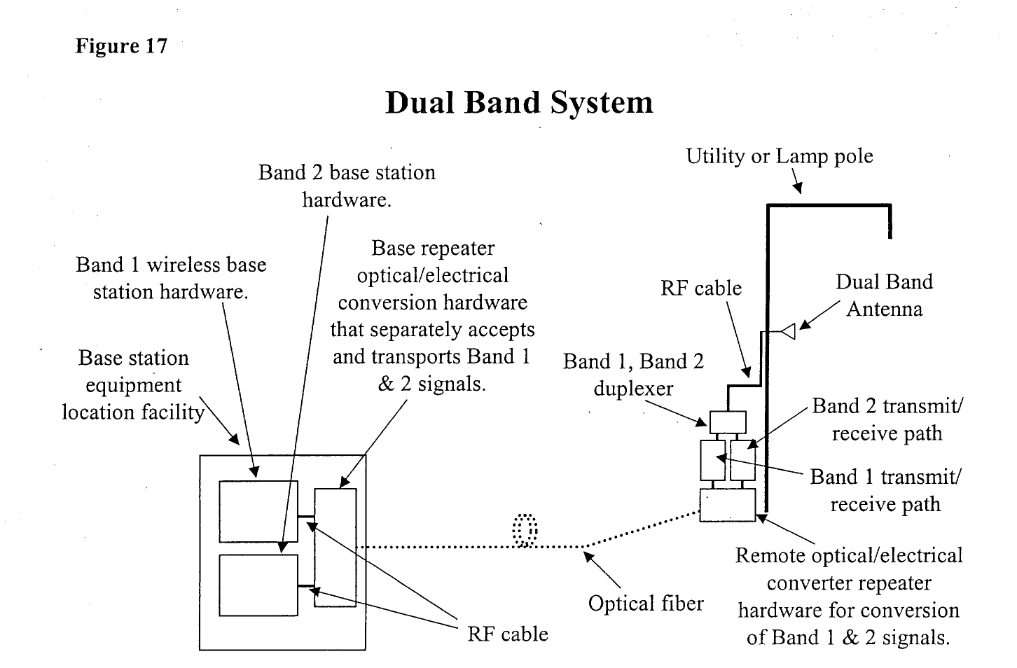

In a preferred embodiment, two different frequency bands (such as PCS and Cellular) can be served by a combined system that employs a single dual band system that uses different transport and radiating equipment for the two bands. The dual band remote box is used that contains two downlink power amplifier systems that feed a single dual band antenna through a frequency duplexer, and two distinct receive chains for each band again fed by the duplexer in the uplink direction. This system is illustrated in FIG. 17. Two different operators or a single operator employing two different frequency bands can occupy the two bands. In other embodiments, the optical link could be an RF link or electrical link to transport the two RF bands.

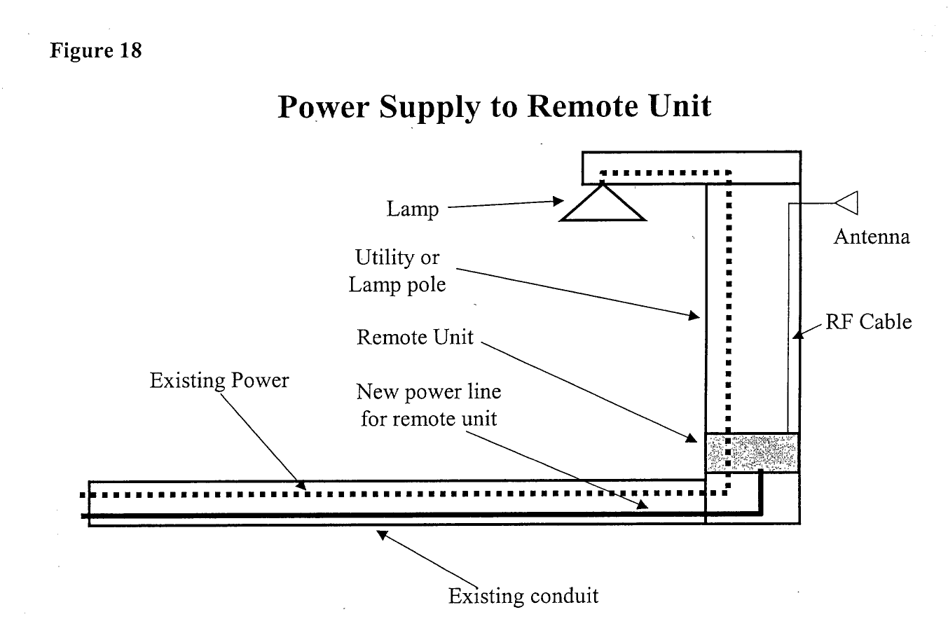

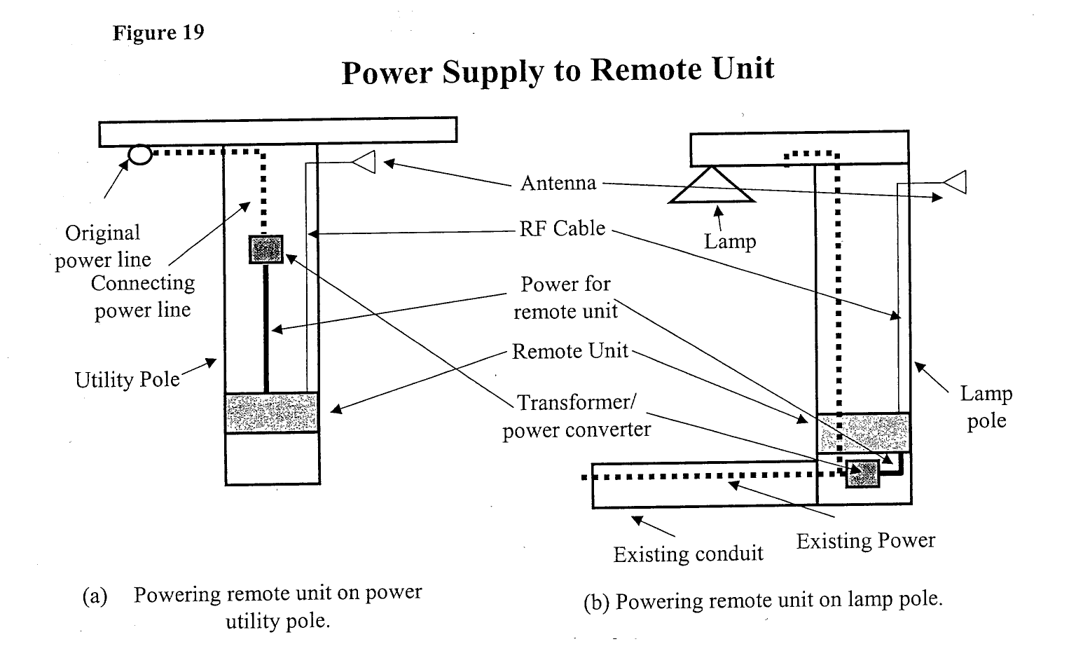

In another embodiment of the invention, the equipment located at the remote pole locations for radiating signals is powered by power run to these devices through the conduit system that currently supports power and communications requirements for the light and utility poles. In another embodiment, the remote equipment is powered directly off of the lamp or utility pole power, employing a transformer/power converter for required voltage, current, and AC/DC conversions. FIG. 18, pulling another cable for dedicated power through existing conduit is illustrated, while in FIG. 19, power supply from existing utility or lamp power is illustrated.

1. An cellular network, comprising:
a plurality of antennas positioned at one or more poles or posts;
a first set of converters coupled to the plurality of antennas, each of a converter configured to convert between distribution network signals and cellular signals;
a distribution network configured to couple the plurality of converters at the antennas to a hub site; and
base station capacity equipment at the hub site coupled to at least one converter; the at least one converter coupled to the distribution network.

2. The network of claim 1 wherein the distribution network is optical fiber.

3. The network of claim 1 wherein the optical distribution network is free space optics.

4. The network of claim 1 wherein the distribution network is RF cabling.

5. The network of claim 1 wherein the distribution network are free space microwave links.

6. The network of claim 1 wherein the poles are selecged from utility, electrical and lighting poles.

7. The network of claim 1 wherein the network is shared by multiple cellular operators.

8. The network of claim 1, further comprising:
a second set of converters that couple the distribution network to the base station capacity equipment.

9. The network of claim 8, wherein the first and second set of converters have different RF characteristics.

10. The network of claim 9, wherein the different RF characteristics are selected from output power and RF frequency.

11. The network of claim 8 wherein the first set of converters convert downlink distribution network signals to downlink cellular signals, amplify the downlink cellular signals and convert uplink cellular signals into distribution network signals, and the second set of converter convert downlink cellular signals into distribution network signals and uplink distribution network signals into cellular signals.

12. The network of claim 1, wherein multiple cellular signals are multiplexed on the distribution network by placing them at different RF frequencies.

13. A cellular distribution network, comprising:
a plurality of antennas located at one or more poles or posts that are selected for cellular coverage;
an optical distribution network;
a first set of converters coupled to the plurality of antennas that converts between optical and RF signals and coupled to the optical distribution network; and
a base station site coupled to the optical distribution network, the base station site including at least one converter that converts between optical and RF signals.

14. The network of claim 13, further comprising:
a second set of converters that couple the distribution network to the base station capacity equipment.

15. The network of claim 14, wherein the first and second set of converters have different RF characteristics.

16. The network of claim 15, wherein the different RF characteristics are selected from output power and RF frequency.

17. The network of claim 14, wherein the first set of converters convert downlink distribution network signals to downlink cellular signals, amplify the downlink cellular signals and convert uplink cellular signals into distribution network signals, and the second set of converter convert downlink cellular signals into distribution network signals and uplink distribution network signals into cellular signals.

18. The network of claim 13, wherein multiple optical wavelength multiplexing is used to multiplex multiple cellular signals on the network.

19. The network of claim 18, wherein multiple wavelengths are distributed and received on the network at a site, and a sub-set of the multiple wavelengths is added or dropped at remote sites.

20. The network of claim 18, wherein different cellular operators are placed on different optical wavelengths.

21. The network of claim 1, in which the first set of converters that are coupled to the antennas are built with lower power downlink RF amplifiers (<40 watts) in order to reduce the size of the remote unit.

22. The network of claim 1, wherein at least a portion of the distribution network is in conduits used to distribute electrical power to poles.

23. The network of claim 1, wherein the distribution network is a double star architecture with a primary star network that distributes signals from a primary hub site to secondary hub sites, and a set of secondary star networks that distributes the signals from the secondary hub sites to the poles.

24. The network of claim 23, wherein the primary and secondary networks use different media or transport protocols to distribute the signals.

25. The network of claim 24, wherein the first start network is optical fiber and the second star network is free space.

26. The network of claim 25, wherein the free space network is microwave.

27. The network of claim 25, wherein the free space network is optical.

28. The network of claim 1, wherein uplink reception from multiple antennas on multiple poles is combined at the base station capacity hub to provide receive diversity.

29. The network of claim 28, further comprising:
a dedicated switch device at the base station capacity hub configured to select the best uplink receive signal.

30. The network of claim 28, further comprising:
a dedicated receive combination device at the base station capacity hub configured to combine multiple uplink signals to form an optimal uplink receive signal.

31. The network of claim 28, wherein different uplink antenna signals from different poles are placed at different uplink receive and receive diversity ports on existing base stations at the base station capacity hub.

32. The network of claim 1, wherein a downlink signal from the base station capacity hub is transmitted from multiple antennas on multiple poles to provide transmit diversity.

33. The network of claim 1, wherein remote units are are coupled to poles in a manner to provide heating dissipation.

34. The network of claim 1, wherein remote units are bonded to metal poles in with a heat conductive device selected to provide heat dissipation capability.

35. The network of claim 13, further comprising:
the first set of converters contains two sets of equipment to convert two different RF bands between optical and RF signals;
the optical distribution system transports two sets of optical signals representing RF signals from the two different RF bands;
the converter at the base station site contains two sets of equipment to convert two different RF bands between optical and RF signals.

36. The network of claim 1, wherein remote equipment at the utility or power poles is powered by a same power distribution system that provides power and communications requirements for the poles.
